(19) United States
(12) Patent Application Publication
(10) Pub. No.: US 2026/0286196 A1
(43) Pub. Date: Sep. 24, 2026

(54) RECYCLABLE SHEET

(71) Applicant: LINTEC CORPORATION, Tokyo (JP)

(72) Inventors: Sho KOSABA, Tokyo (JP); Kentaro KUSAMA, Tokyo (JP); Takayuki ARAI, Tokyo (JP)

(73) Assignee: LINTEC CORPORATION, Tokyo (JP)

(21) Appl. No.: 19/168,147

(22) PCT Filed: Feb. 6, 2024
(86) PCT No.: PCT/JP2024/003798

§ 371 Date: Sep. 23, 2025

(30) Foreign Application Priority Data
Mar. 28, 2023 (JP) 2023-051352

(51) Int. Cl. C09J 7/40

(52) U.S. Cl. CPC C09J 7/401; C09J 2451/005

(57) ABSTRACT

A recyclable sheet includes: a base material; an undercoat layer provided on at least one surface side of the base material; and a functional layer provided on the undercoat layer on the side opposite the base material, the undercoat layer containing a cyclodextrin compound. The gel fraction of the material constituting the undercoat layer is preferably 20% or less. The undercoat layer preferably contains the cyclodextrin compound as a monomer, and preferably further contains an acrylic monomer. The above recyclable sheet allows the base material to be recycled.

### TECHNICAL FIELD

The present invention relates to a recyclable sheet whose base material can be recycled.

### BACKGROUND ART

In recent years, there has been a growing demand for the creation of a recycling-based society, and various products and materials are required to be recyclable.

For example, when a product with a specific coating (e.g., a functional layer having a specific function) formed on a base material made of plastic or the like is discarded, removing the coating from the base material may allow the base material to be reused.

Patent Document 1, under the purpose of providing a material for forming a film (a composition for forming a film) that makes it possible to easily remove a film layer from a base material such as a general-purpose plastic substrate by detaching the film with ease from the base material by a simple method using neutral water, proposes a composition for forming a film that contains a removal removal promotor has a promotor, wherein the above hydrophilic functional group protected by protective groups and exhibits hydrophilicity when the protective groups are deprotected by treatment such as heating.

Most recently, novel materials cyclodextrin monomers have been proposed. Specifically, Patent Document 2 proposes a polymer material that contains a crosslinked polymer obtained by being crosslinked as a result of an interaction between a host group and a guest group. The host group is a monovalent group obtained by removing one hydrogen atom or one hydroxyl group from cyclodextrin. The above crosslinked polymer includes a predetermined repeating structural unit.

Patent Document 3 proposes an inclusion complex that is formed from the host group of a host group-containing monomer and the guest group of a guest group-containing monomer. The host group-containing monomer is a cyclodextrin monomer derivative having a (meth)acryloyl group. The guest group-containing monomer is a predetermined monomer having a vinyl group.

### PRIOR ART DOCUMENTS

### Patent Documents

Patent Document 1: JP 2022-183764A
Patent Document 2: JP6636610B
Patent Document 3: JP6239043B

### SUMMARY OF THE INVENTION

### Problems to be Solved by the Invention

However, nothing in Patent Documents 2 and 3 makes a mention of removing the film (functional layer) from the base material or of recyclability.

The present invention has been made in view of such actual circumstances as above, and an object of the present invention is to provide a recyclable sheet whose base material can be recycled.

### Means for Solving the Problems

To achieve the above object, first, the present invention provides a recyclable sheet comprising: a base material; an undercoat layer provided on at least one surface side of the base material; and a functional layer provided on the undercoat layer on a side opposite the base material, the undercoat a cyclodextrin compound

### (Invention 1).

In the above invention (Invention 1), the undercoat layer containing a cyclodextrin compound, which is a cyclic molecule having an opening portion, has a low coating density and excellent solvent solubility. Therefore, by performing immersion or the like of the above recyclable sheet in a predetermined solvent, the undercoat layer dissolves in the solvent, and the undercoat layer and the functional layer are detached from the base material. This allows the base material to be reused.

In the above invention (Invention 1), the material constituting the undercoat layer preferably has a gel fraction of 20% or less (Invention 2).

In the above invention or inventions (Inventions 1 and 2), the undercoat layer preferably contains the cyclodextrin compound as a monomer (Invention 3).

In the above invention or inventions (Inventions 1 to 3), the cyclodextrin compound is preferably a compound in which some or all of hydroxyl groups of cyclodextrin are substituted with acyl groups (Invention 4).

In the above invention or inventions (Inventions 1 to 4), the undercoat layer preferably contains an acrylic monomer (Invention 5).

In the above invention or inventions (Inventions 1 to 5), the content of the cyclodextrin compound in the undercoat layer is preferably 0.01 mass % or more and 30 mass % or less (Invention 6).

In the above invention or inventions (Inventions 1 to 6), the undercoat layer preferably has a thickness of 0.01 μm or more and 10 μm or less (Invention 7).

In the above invention or inventions (Inventions 1 to 7), the functional layer is preferably a release agent layer, and the recyclable sheet is preferably a release sheet (Invention 8).

### Advantageous Effect of the Invention

The recyclable sheet according to the present invention allows the base material to be recycled.

### BRIEF DESCRIPTION OF THE DRAWINGS

FIG. 1 is a cross-sectional view of recyclable sheet according to an embodiment of the present invention.

### EMBODIMENTS FOR CARRYING OUT THE INVENTION

One or more embodiments of the present invention will be described below.

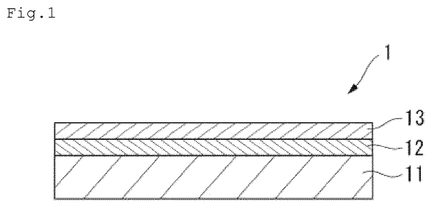

The recyclable sheet according to an embodiment of the present invention includes a base material, an undercoat layer provided on at least one surface side of the base material, and a functional layer provided on the undercoat layer on the side opposite the base material, and the above undercoat layer contains a cyclodextrin compound. A specific 10 configuration of an example of the recyclable sheet according to the present embodiment is illustrated in FIG. 1.

As illustrated in FIG. 1, recyclable sheet 1 according to the present embodiment includes, from the bottom up, a base material 11, an undercoat layer 12 laminated on the base material 11, and a functional layer 13 laminated on the undercoat layer 12.

### 1. Elements

### (1) Base Material

The base material 11 in the recyclable sheet 1 according to the present embodiment is not particularly limited, provided that it is resistant to the solvent used to dissolve the undercoat layer 12, and can be selected appropriately depending on the intended use of the recyclable sheet 1.

Specific examples of the base material 11 include polyester films such as those of polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, ethylene-(meth)acrylic acid copolymer films, ethylene-(meth)acrylic ester copolymer films, polystyrene films, polycarbonate films, polymethylpentene films, polysulfone films, polyether ether ketone films, polyether sulfone films, polyether imide films, fluororesin films, polyamide films, polyimide films, acrylic resin films, polyurethane resin films, ionomer resin films, norbornene-based polymer films, cyclic olefin-based polymer films, cyclic conjugated diene-based polymer films, vinyl alicyclic hydrocarbon polymer films, and other plastic films or laminated films thereof; woven or nonwoven fabrics using fibers such as those of rayon, acrylic, and polyester; papers such as high-quality paper, glassine paper, impregnated paper, and coated paper; metal foils such as those of aluminum and copper; foams such as urethane foam and polyethylene foam; and laminates of two or more of these.

From the viewpoint of the SDGs, the material constituting the base material 11 for use may be a highly biomass material, a recyclable or reusable material, or a recycled or reused material.

The thickness of the base material 11 varies depending on its type and application, but is ordinarily preferably 10 to 200 μm, more preferably 20 to 160 μm, particularly preferably 30 to 120 μm, further preferably 40 to 100 μm, and especially preferably 45 to 80 μm.

### (2) Undercoat Layer

The undercoat layer 12 in the recyclable sheet 1 according to the present embodiment preferably contains a cyclodextrin compound. The cyclodextrin compound is a cyclic molecule having an opening portion. By containing a cyclodextrin compound having such a structure, the undercoat layer 12 has a reduced coating density, improved swelling/wetting properties due to a solvent, and excellent solvent solubility. Therefore, by performing immersion or the like of the recyclable sheet 1 according to the present embodiment in a predetermined solvent, the undercoat layer 12 dissolves in the solvent, and the undercoat layer 12 and the functional layer 13 are detached from the base material 11. This allows the base material 11 to be reused. Thus, the recyclable sheet 1 according to the present embodiment is excellent in the base material recyclability. The solvent used during recycling will be described later.

The cyclodextrin compound may be cyclodextrin itself, cyclodextrin (cyclodextrin derivative) having a substituent, or cyclodextrin or cyclodextrin derivative incorporated into a polymer (a polymer having cyclodextrin or a cyclodextrin derivative as a constituent monomer), but it is preferred for the cyclodextrin compound to be present in the undercoat layer 12 in the form of a monomer. This can improve the solvent solubility of the undercoat layer 12. That is, the cyclodextrin compound is preferably cyclodextrin itself or cyclodextrin (cyclodextrin derivative) having a substituent.

The cyclodextrin skeleton of the cyclodextrin compound is preferably α-cyclodextrin, β-cyclodextrin, or γ-cyclodextrin, among which β-cyclodextrin or γ-cyclodextrin is preferred from the viewpoint of better solvent solubility. Also from the viewpoint of solvent solubility, the cyclodextrin compound preferably has a substituent. It is therefore particularly preferred that the cyclodextrin compound should be β-cyclodextrin or γ-cyclodextrin having a substituent.

The above substituent is a substitution of a hydroxyl group possessed by the cyclodextrin. Examples of the above substituent include an acyl group, an alkyl group, a trityl group, a tosyl group, a trimethylsilane group, a phenyl group, an amide group, a (meth)acryloyl group, etc.; (meth)acrylamide, an N-monoalkyl(meth)acrylamide, an N-dialkyl(meth)acrylamide, etc.; and a polyester chain, an oxyethylene chain, an alkyl chain, an ether chain, an ester chain, an acrylic ester chain, etc. As used in the present specification, the term “(meth)acrylic” refers to both the acrylic and the methacrylic. The same applies to other similar terms.

The cyclodextrin compound is preferably a compound in which some or all of the hydroxyl groups of cyclodextrin are substituted with acyl groups. The acyl groups are particularly preferably acetyl groups. This improves the solvent solubility of the undercoat layer 12.

In the cyclodextrin compound, it is preferred that hydroxyl groups of the cyclodextrin should not remain, it is hydroxyl groups should be more preferred that some substituted with (meth)acrylamide or a derivative thereof and all of the remaining hydroxyl groups should be substituted with acyl groups, particularly acetyl groups, and it is further preferred that one hydroxyl group should be substituted with (meth)acrylamide or a derivative thereof and all of the remaining hydroxyl groups should be substituted with acyl groups, particularly acetyl groups. Preferred examples of the (meth)acrylamide derivatives include N-monoalkyl(meth)acrylamides and N-dialkyl(meth)acrylamides, among which N-methyl (meth)acrylamide is particularly preferred, and N-methylacrylamide is further preferred. This improves the solvent solubility of the undercoat layer 12.

The content of the cyclodextrin compound in the undercoat layer 12 is preferably 0.01 to 30 mass %, more preferably 0.3 to 20 mass %, particularly preferably 0.6 to mass %, and further preferably 0.9 to 5 mass %. This improves the solvent solubility of the undercoat layer 12. The undercoat layer 12 can also contain appropriate amounts of other components, for example, acrylic monomers to be described later, which can improve the functionality due to those components, for example, the film strength.

The undercoat layer 12 in the present embodiment is preferably free from a guest molecule that can be included in the above cyclodextrin compound. In the present specification, inclusion refers to a phenomenon that a guest molecule is taken into a cavity possessed by a host molecule (cyclodextrin compound). The guest molecule in the present specification refers to a molecule that can be included in the cyclodextrin compound, and such molecules include those that have not yet been included the cyclodextrin compound. Examples of such guest molecules include n-butyl acrylate, styrene, octyl acrylate, and dodecyl acrylate for α-cyclodextrin compounds, n-butyl acrylate, t-butyl acrylate, styrene, adamantyl acrylate, and isobornyl acrylate for β-cyclodextrin compounds, and octyl acrylate and dodecyl acrylate for γ-cyclodextrin compounds.

In the present specification, the undercoat layer being “free from a guest molecule that can be included in the cyclodextrin compound” means that the undercoat layer does not substantially contain a guest molecule that can be included in the cyclodextrin compound. Specifically, it is allowed that the undercoat layer may contain guest molecules in an amount of 0.1 mass % or less, preferably 0.01 mass % or less, particularly preferably 0.001 mass % or less, and further preferably 0.0001 mass % or less.

The undercoat layer 12 preferably contains an acrylic monomer in addition to the cyclodextrin compound. This can improve the film strength of the undercoat layer 12 and allows the functional layer 13 to be formed/supported satisfactorily on the undercoat layer 12. One type of the acrylic monomer may be used alone or two or more types may also be used in combination.

The acrylic monomer is preferably a monofunctional acrylic monomer and particularly preferably a (meth)acrylic ester. This improves the film strength of the undercoat layer 12 while also improving the solvent solubility of the undercoat layer 12. From the viewpoint of the SDGs, the acrylic monomer for use may be a highly biomass one, a recyclable or reusable one, or a recycled or reused one.

Examples of the (meth)acrylic ester include (meth)acrylic alkyl ester having a linear or branched alkyl group, (meth)acrylic ester having a cyclic structure such as an alicyclic structure, and (meth)acrylic ester having a functional group such as a hydroxyl group. Among these, (meth)acrylic alkyl esters in which the alkyl group is linear or branched are preferred, and (meth)acrylic alkyl esters in which the alkyl group is linear are particularly preferred.

From the viewpoints of the film strength and solvent solubility, the above (meth)acrylic alkyl ester is preferably (meth)acrylic alkyl ester whose carbon number of alkyl group is 1 to 20. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, n-octyl isooctyl (meth)acrylate, (meth)acrylate, n-dodecyl (meth)acrylate, n-decyl (meth)acrylate, palmityl (meth)acrylate, myristyl (meth)acrylate, and stearyl (meth)acrylate. Among these, those whose carbon number of alkyl group is 1 to 8 are preferred, those whose carbon number of alkyl group is 1 to 6 are more preferred, those whose carbon number of alkyl group is 1 to 4 are particularly preferred, and those whose carbon number of alkyl group is 1 to 2 are further preferred, from the viewpoint of improving the solvent solubility. Specifically, methyl (meth)acrylate, ethyl (meth)acrylate, propyl (meth)acrylate, n-butyl (meth)acrylate, etc. are preferred, methyl (meth)acrylate or ethyl (meth)acrylate is particularly preferred, and methyl acrylate or ethyl acrylate is further preferred.

The content of the acrylic monomer in the undercoat layer 12 is preferably 70 to 99.9 mass %, more preferably 80 to 99.6 mass %, particularly preferably 90 to 99.3 mass %, and further preferably 95 to 99.1 mass %. This results in good film strength and improved solvent solubility.

The undercoat layer 12 may contain components other than the cyclodextrin compound and the acrylic monomer, provided that they do not impair the function of the undercoat layer 12, but it is preferred that the undercoat layer 12 should contain essentially only the cyclodextrin compound and the acrylic monomer. Specifically, the total content of the cyclodextrin compound and acrylic monomer in the undercoat layer 12 is preferably 50 mass % or more, more preferably 75 mass % or more, particularly preferably 90 mass % or more, further preferably 95 mass % or more, especially preferably 99 mass % or more, and most preferably 100 mass %.

The ratio (molar ratio) of the acrylic monomer to the cyclodextrin compound in the undercoat layer 12 is preferably 50:50 to 99.9:0.1, more preferably 75:25 to 99.5:0.5, particularly preferably 80:20 to 99.2:0.8, and further preferably 85:15 to 99.1:0.9. This allows for a balance between the excellent solvent solubility and the good film strength.

The gel fraction of the material (composition) constituting the undercoat layer 12 is preferably 20% or less, more preferably 15% or less, particularly preferably 10% or less, further preferably 7% or less, and especially preferably 5% or less. The lower limit of the gel fraction is preferably 0%. This improves the solvent solubility of the undercoat layer 12. The measurement method for the gel fraction in the present specification is as described in the testing example, which will be described later.

The thickness of the undercoat layer 12 is preferably 0.01 to 10 μm, more preferably 0.03 to 6 μm, particularly preferably 0.06 to 3 μm, further preferably 0.09 to 1 μm, and especially preferably 0.1 to 0.7 μm. This allows for a balance between the excellent solvent solubility and the good film strength.

### (3) Functional Layer

The functional layer 13 in the recyclable sheet 1 according to the present embodiment is a layer having desired functions. Examples of the functions of the functional layer 13 include, but are not limited to, releasability, hard coating properties (scratch resistance), self-repairing properties, reflectivity, semi-transparency, anti-reflective properties, anti-glare properties, fingerprint resistance, easy glidant ability, antistatic properties, writing feel improving properties, anti-Newton ring properties, colorability, light diffusion properties, specific wavelength blocking properties, design properties, and anti-fogging properties.

Among the above, the function of the functional layer 13 is preferably releasability, that is, the functional layer 13 is preferably a release layer. In this case, the recyclable sheet 1 can be used as a release sheet. The release sheet is ordinarily discarded after being removed from the layer it protects, such as a pressure sensitive adhesive layer, an adhesive layer, a hard coat layer, a self-repairing layer, a writing feel improving layer, or a ceramic green sheet, but when the recyclable sheet 1 according to the present embodiment is used as a release sheet, the base material 11 can be recycled even after the removal (after the use).

The release layer can be formed using a release agent. The type of the release agent is not particularly limited, and examples thereof include silicone-based, fluorine-based, alkyd-based, melamine resin-based, unsaturated polyester-based, polyolefin-based, and wax-based release agents.

Preferred examples of the silicone-based release agents for use include those containing an addition reaction-type silicone resin obtained from a first organopolysiloxane having at least two alkenyl groups (e.g., vinyl groups) in one molecule and a second organopolysiloxane (corresponding to a crosslinker) having at least two hydrosilyl groups in one molecule, and a silicone resin. Examples of silicone resins for use include MQ resins composed of M units, which are monofunctional siloxane units [(CH₃)₃SiO_{1/2}], and Q units, which are tetrafunctional siloxane units [SiO_{4/2}]. In such silicone-based release agents as above, the hardness of the release agent layer can be adjusted by the skeleton of the addition reaction-type silicone resin, and the surface polarity can be adjusted by the compounding amount of the silicone resin, thereby achieving the desired surface free energy and releasability.

The thickness of the functional layer 13 varies depending on its type and application, but is ordinarily preferably 0.01 to 100 μm, more preferably 0.04 to 60 μm, particularly preferably 0.08 to 20 μm, and further preferably 0.1 to 10 μm. In particular, when the functional layer 13 is a release layer, its thickness is preferably 0.2 to 7 μm, more preferably 0.4 to 4 μm, particularly preferably 0.6 to 3 μm, and further preferably 0.8 to 2 μm.

### 2. Production Method

To produce the recyclable sheet 1 according to the present embodiment, the undercoat layer 12 is first formed on the base material 11. To form the undercoat layer 12, it is preferred to first prepare a coating liquid of the material (composition) constituting the undercoat layer 12.

Specifically, the coating liquid is obtained by mixing a cyclodextrin compound and, if desired, an acrylic monomer, a dilution solvent, etc.

Examples of the above dilution solvent for use include aliphatic hydrocarbons such as hexane, heptane, and cyclohexane, aromatic hydrocarbons such as toluene and xylene, halogenated hydrocarbons such as methylene chloride and ethylene chloride, alcohols such as methanol, ethanol, propanol, butanol, and 1-methoxy-2-propanol, ketones such as acetone, methyl ethyl ketone, 2-pentanone, isophorone, and cyclohexanone, esters such as ethyl acetate and butyl acetate, and cellosolve-based solvents such as ethyl cellosolve.

The concentration/viscosity of the above coating liquid are not particularly limited, provided that they are within a coatable range, and can be selected appropriately depending on the situation. For example, the coating liquid is diluted so that the concentration of the composition in the coating liquid is 10 to 40 mass %. The addition of a dilution solvent or the like is not a necessary condition when obtaining the coating liquid, and no dilution solvent may be added if the composition has a coatable viscosity, or the like.

Once the coating liquid for the undercoat layer 12 is obtained, it is applied onto the base material 11 and the coating layer is dried to form the undercoat layer 12. Coating methods for use include gravure coating, bar coating, spray coating, spin coating, knife coating, roll coating, and die coating methods.

When drying the coating layer, heat treatment may be performed. When heat treatment is performed, the heating temperature is preferably 50° C. to 150° C. and particularly preferably 70° C. to 110° C. The heating time is preferably 10 seconds to 10 minutes and particularly preferably 30 seconds to 2 minutes.

Once the undercoat layer 12 is formed as described above, the functional layer 13 is then formed on the undercoat layer 12. The functional layer 13 can be formed using known methods depending on the type, material, etc. of the functional layer 13. Here, the description will be made for the case in which the functional layer 13 is a release layer.

To form the release layer, a coating liquid for the release agent constituting the release layer is prepared. Specifically, the release agent (each component of it) and, if desired, additives, dilution solvents, etc. are mixed to obtain the coating liquid for the release agent. The release agent coating liquid thus obtained is applied to the undercoat layer 12, and the coating layer is cured to form the release layer. The dilution solvent and coating method are the same as those for the undercoat layer 12.

The curing method for the coating layer of the release agent can be selected appropriately depending on the type of the release agent, and thermal curing by heat treatment or active energy ray curing by irradiation with active energy rays can be selected.

In the case of thermal curing, the heating temperature is preferably 50° C. to 160° C. and particularly preferably 70° C. to 130° C. The heating time is preferably 10 seconds to 10 minutes and particularly preferably 30 seconds to 3 minutes.

In the case of active energy ray curing, ultraviolet rays, electron rays, etc. are ordinarily used as the active energy rays, and ultraviolet rays are particularly preferred. The irradiation amount of the active energy rays varies depending on the type of energy rays, but in the case of ultraviolet rays, for example, the irradiation amount as the light amount is preferably 50 to 1,000 mJ/cm² and particularly preferably 100 to 500 mJ/cm². In the case of electron rays, it is preferably approximately 0.1 to 50 kGy.

### 3. Recycling Method

When recycling the recyclable sheet 1 according to the present embodiment, it is preferred to immerse the recyclable sheet 1 in a solvent that readily dissolves the undercoat layer 12 but poorly dissolves the base material 11. This allows the undercoat layer 12 to be dissolved in the solvent, and the undercoat layer 12 and the functional layer 13 are detached from the base material 11. As a result, the base material 11 can be reused.

Solvents that can be used to dissolve the undercoat layer 12 during the recycling include, for example, aliphatic hydrocarbons such hexane, heptane, and cyclohexane, aromatic hydrocarbons such as toluene and xylene, halogenated hydrocarbons such as methylene chloride and ethylene chloride, alcohols such as methanol, ethanol, propanol, butanol, and 1-methoxy-2-propanol, ketones such as acetone, methyl ethyl ketone, 2-pentanone, isophorone, and cyclohexanone, esters such as ethyl acetate and butyl acetate, and cellosolve-based solvents such as ethyl cellosolve.

The time for immersing the recyclable sheet 1 in the solvent varies depending on the size of the recyclable sheet 1, the type and thickness of the functional layer 13, etc., but is preferably 0.5 to 48 hours, more preferably 1 to 36 hours, particularly preferably 1.5 to 24 hours, and further preferably 2 to 12 hours. This allows the time until the undercoat layer 12 and the functional layer 13 are detached from the base material 11 to be relatively short, thus contributing to a reduction in the recycling process time.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, one or more other layers may be provided on the undercoat layer 12 side of the functional layer 13 or on the side of the functional layer 13 opposite the undercoat layer 12. Furthermore, the base material 11 may be composed of two or more layers, or one or more other layers that remain on the base material 11 side even after solvent immersion may be provided between the base material 11 and the undercoat layer 12.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples, etc., but the scope of the present invention is not limited to these examples, etc.

### Production Example 1

In 100 mL of dimethylformamide, 15 g of β-cyclodextrin and 2.0 g of N-hydroxymethylacrylamide were dissolved. To this, 500 mg of para-toluenesulfonic acid monohydrate was added and stirred at 80° C. for 30 minutes. The solution was then allowed to cool in the air and added dropwise to 500 mL of acetone, and the resulting precipitate was collected by filtration. The solid thus obtained was purified by HPLC to yield 2.9 g of a white solid.

In 80 mL of pyridine, 2.9 g of the above white solid was dissolved along with 25 g of acetic anhydride. Subsequently, the mixture was stirred at 55° C. for 12 hours and then added dropwise to 300 mL of purified water. The precipitate thus obtained was dried under reduced pressure to yield 3.5 g of a white solid. A portion of the white solid was dissolved in deuterated chloroform and analyzed with 1H-NMR (available from JEOL Ltd., product name “Nuclear Magnetic Resonance Apparatus JNM-LA400/WB”). As a result of the analysis, it has been found that the white solid is a cyclodextrin compound in which one hydroxyl group in β-cyclodextrin is substituted with N-methylacrylamide and all remaining hydroxyl groups are substituted with acetyl groups. This cyclodextrin compound is referred to as a cyclodextrin compound (CD2).

### Production Example 2

To 8.5 ml of isopropenyl acetate as a solvent, 1.8 g of β-cyclodextrin (available from NACALAI TESQUE, INC.) and 47 mg of p-toluenesulfonic acid monohydrate as a catalyst were added and reacted at 70° C. for 16 hours. After the reaction solution was distilled under reduced pressure and the obtained solid was washed with a 10 mass % sodium carbonate aqueous solution, 2.5 g of acetylated β-cyclodextrin was obtained as a white solid through extraction with chloroform and recrystallization with acetone.

A portion of the acetylated β-cyclodextrin thus obtained was dissolved in deuterated chloroform and analyzed with 1H-NMR (available from JEOL Ltd., product name “Nuclear Magnetic Resonance Apparatus JNM-LA400/WB”). As a result of the analysis, the degree of modification was calculated as 2.98 from the integral ratio of the peak derived from the proton attached to the first carbon of the glucose ring near 5.1 ppm and the peak derived from the acetyl group near 2.1 ppm in the 1H-NMR chart. This acetylated β-cyclodextrin is referred to as a cyclodextrin compound (CD3).

### Example 1

1. Preparation of Coating liquid for Undercoat Composition

A cyclodextrin compound (available from YUSHIRO INC., product name “Wizard Monomer ACCD-S”) was prepared in which one hydroxyl group in β-cyclodextrin was substituted with acrylamide and all remaining hydroxyl groups were substituted with acetyl groups. This cyclodextrin compound is referred to as a cyclodextrin compound (CD1).

In ethyl acetate, 100 mol % of methyl acrylate as an acrylic monomer and 1 mol % of the above cyclodextrin compound (CD1) were mixed and sufficiently stirred to obtain a coating liquid of the composition for the undercoat layer (undercoat composition).

### 2. Preparation of Release Agent Coating Liquid

A release agent coating liquid for forming a release layer as the functional layer was obtained through mixing and sufficiently stirring 100 mass parts of an addition-type release agent (available from Shin-Etsu Chemical Co., Ltd., product name “KS-847H”), 15 mass parts of an addition-type silicone resin (available from Dow Toray Co., Ltd., product name “DOWSIL SD-4584”), 2.0 mass parts of a curing catalyst (available from Dow Toray Co., Ltd., product name “DOWSIL SRX 212 Catalyst”), and toluene as a diluent.

### 3. Production of Recyclable Sheet

The coating liquid of the undercoat composition obtained in the above step 1 was applied using a coater to the surface opposite an easy adhesion layer of a polyethylene terephthalate (PET) film (available from TOYOBO CO., LTD., product name “COSMOSHINE A4160,” thickness: 50 μm) as the base material whose one surface is provided with the easy adhesion layer. It was then dried by heating at 70° C. for 60 seconds to form an undercoat layer having a thickness of 0.1 μm. The thickness of the above undercoat layer is a value measured using a constant-pressure thickness meter (available from TECLOCK Co., Ltd., product name “PG-02”) according to JIS K7130 (here and hereinafter).

Then, the release agent coating liquid obtained in the above step 2 was applied to the exposed surface of the above undercoat layer using a coater. After that, the coating layer was heat-treated at 120° C. for 120 seconds to thermally cure the coating layer to form a release layer (R1) having a thickness of 1 μm. In this way, a recyclable sheet composed of release layer (1 μm)/undercoat layer (0.1 μm)/base material (50 μm) was produced.

### Examples 2 and 4 to 7 and Comparative Examples 1 to 3

Recyclable sheets were produced in the same manner as in Example 1 except that the type of the acrylic monomer, the type of the cyclodextrin compound, and the thickness of the undercoat layer were as listed in Table 1. In Comparative Example 3, dimethylol-tricyclodecane diacrylate was used in place of the cyclodextrin compound, and its compounding amount was 0.2 mol %.

### Example 3

A release agent coating liquid for forming a release layer as the functional layer was obtained through mixing and sufficiently stirring 100 mass parts of dipentaerythritol hexaacrylate, 5 mass parts of polydimethylsiloxane (available from Dow Toray Co., Ltd., product name “SH28”), and 5 mass parts of a photopolymerization initiator (available from BASF, product name “Irgacure 904”).

The above release agent coating liquid was applied to the exposed surface of the undercoat layer formed on the base material in the same manner as in Example 1. After that, the coating layer was irradiated with active energy rays (ultraviolet rays; UV) under the following conditions to cure the coating layer to form a release layer (R2) having a thickness of 1 μm. In this way, a recyclable sheet composed of release layer (1 μm)/undercoat layer (0.1 μm)/base material (50 μm) was produced.

### <<Activin Energy Ray Irradiation Conditions>>

Using a high-pressure mercury lamp
Illuminance of 200 mW/cm² and light amount of 500 mJ/cm²
Using “UVPF-A1” available from EYE GRAPHICS CO., LTD. as a UV illuminance/light amount meter

### Comparative Example 4

A laminate sheet (which may be referred to as a “recyclable sheet” for convenience) was produced in the same manner as in Example 1 except that an undercoat layer was not formed. This laminate sheet was composed of release layer (1 μm)/base material (50 μm).

### Comparative Example 5

A laminate sheet (which may be referred to as a “recyclable sheet” for convenience) was produced in the same manner as in Example 2 except that an undercoat layer was not formed. This laminate sheet was composed of undercoat layer (0.5 μm)/base material (50 μm).

Details of the simplified names listed in Table 1 and additional information are as follows.

### [Acrylic Monomers]

MA: methyl acrylate
EA: ethyl acrylate
DCP: dimethyloltricyclodecane diacrylate

### [Cyclodextrin Compounds]

CD1: cyclodextrin compound (available from YUSHIRO INC., product name “Wizard Monomer ACCD-S”)
CD2: cyclodextrin compound produced in Production Example 1
CD3: cyclodextrin compound produced in Production

### Example 2

### <Testing Example 1> (Measurement of Gel Fraction)

The coating liquid for the undercoat composition prepared in each of Examples and Comparative Examples (except Comparative Example 4) was applied using a coater to the release-treated surface of a release sheet obtained by release-treating one surface of a polyethylene terephthalate film. It was then dried by heating at 70° C. for 60 seconds to form an undercoat layer having a thickness of 50 μm.

The laminate sheet composed of the undercoat layer/release sheet prepared as described above was cut into a size of 80 mm×80 mm. Then, the undercoat layer (undercoat composition) was wrapped in a polyester mesh (mesh size of 200), the mass was weighed with a precision balance, and the mass of the undercoat composition alone was calculated by subtracting the mass of the above mesh itself. The mass at that time is M1.

Then, the undercoat composition wrapped in the above polyester mesh was immersed in ethyl acetate at room temperature (23° C.) for 24 hours. After that, the undercoat composition was taken out, air-dried under an environment of a temperature of 23° C. and a relative humidity of 50% for 24 hours, and further dried in an oven at 80° C. for 12 hours. After the drying, the mass was weighed with a precision balance, and the mass of the undercoat composition alone was calculated by subtracting the mass of the above mesh itself. The mass at that time is M2. The gel fraction (%) is represented by (M2/M1)×100. Through this operation, the gel fraction of the undercoat composition was derived. The results are listed in Table 2.

### <Testing Example 2> (Evaluation of Scratch Resistance/Interfacial Adhesion to Base Material)

The surface of the release layer (undercoat layer in Comparative Example 5) of the recyclable sheet produced in each of Examples and Comparative Examples was rubbed back and forth 10 times with a nonwoven fabric (available from Asahi Kasei Corp., product name “BEMCOT”) under conditions of a load of 380 g/cm² and a speed of 100 mm/s. The condition of the release layer/undercoat layer after that was visually confirmed, and the evaluation of scratch resistance/interfacial adhesion to base material was performed according to the following criteria. The results are listed in Table 2.
⊚ . . . No scratches or delamination on the release layer/undercoat layer.
◯ . . . Scratches on the release layer/undercoat layer, but no delamination.
Δ . . . Scratches on the release layer/undercoat layer, with partial delamination.
X . . . Delamination of the release layer or undercoat layer.

### <Testing Example 3> (Measurement of Peel Strength)

A 25 mm wide pressure sensitive adhesive tape (available from Nitto Denko Corporation, product name “No. 31B”) was attached to the surface of the release layer (undercoat layer in Comparative Example 5) of the recyclable sheet produced in each of Examples and Comparative Examples using a 5 kg roller and then stored for 24 hours, which was used as a sample for peel strength measurement. The sample was fixed to a universal tensile tester (available from Shimadzu Corporation, product name “Autograph AGS-20NX”), and the pressure sensitive adhesive tape was peeled from the release agent layer in a 180° direction at a tensile speed of 0.3 m/min according to JIS K6854: 1999, thereby measuring the peel strength (initial; mN/25 mm) of the recyclable sheet.

The results are listed in Table 2.

### <Testing Example 4> (Evaluation of Solvent Immersion Detachability)

The recyclable sheet produced in each of Examples and Comparative Examples was cut into 10 cm×7 cm, which was used as a sample. The sample was immersed in methyl ethyl ketone at room temperature (23° C.) for 2 hours, then taken out, and air-dried.

The peel strength (after solvent immersion; mN/25 mm) of the surface of the release layer (undercoat layer in Comparative Example 5) of the recyclable sheet obtained above after solvent immersion was measured in the same manner as in Testing Example 3. The results are listed in Table 2.

The ratio of change in the peel strength after the solvent immersion relative to the initial peel strength measured above (ratio of change in peel strength=(peel strength after solvent immersion/initial peel strength)×100(%)) calculated. Then, the solvent immersion was detachability of the release layer/undercoat layer in the recyclable sheet was evaluated based on the following criteria. A larger ratio of change in the peel strength indicates a greater degree of detachment of the release layer (and undercoat layer). The results are listed in Table 2.
◯ . . . Ratio of change in peel strength was 2000% or more.
Δ . . . Ratio of change in peel strength was 200% or more and less than 2000%.
X . . . Ratio of change in peel strength was less than 200%.

TABLE 1

| | Undercoat layer | | | | |
|---|---|---|---|---|---|
| | Composition | | | Release layer | |
| | Acrylic | Cyclodextrin | Thickness | | Thickness |
| | monomer | compound | (μm) | Type | (μm) |
| Example 1 | MA | CD1 | 0.1 | R1 | 1 |
| Example 2 | | | 0.5 | | |
| Example 3 | | | 0.5 | R2 | |
| Example 4 | MA | CD2 | 0.5 | R1 | |
| Example 5 | EA | CD1 | 0.5 | | |
| Example 6 | MA | CD3 | 0.1 | | |
| Example 7 | | | 0.5 | | |
| Comparative | MA | — | 0.1 | | |
| Example 1 | | | | | |
| Comparative | | | 0.5 | | |
| Example 2 | | | | | |
| Comparative | MA + DCP | — | 0.5 | | |
| Example 3 | | | | | |
| Comparative | None | | | | |
| Example 4 | | | | | |
| Comparative | MA | CD1 | 0.5 | None | |
| Example 5 | | | | | |

TABLE 2

| | | Scratch | | Peel | | |
|---|---|---|---|---|---|---|
| | Gel | Resistance/ | | strength | Ratio of | |
| | fraction of | interfacial | Initial | after | change | |
| | undercoat | adhesion to | peel | solvent | in peel | Solvent |
| | composition | base | strength | immersion | strength | Immersion |
| | % | material | mN/25 mm | mN/25 mm | % | Detachability |
| Example 1 | <5 | ◯ | 65 | 2500 | 3846 | ◯ |
| Example 2 | <5 | ◯ | 75 | 4750 | 6333 | ◯ |
| Example 3 | <5 | ⊚ | 600 | 5850 | 975 | ◯ |
| Example 4 | 9 | ◯ | 60 | 3750 | 6250 | ◯ |
| Example 5 | <5 | Δ | 120 | 4000 | 3333 | ◯ |
| Example 6 | <5 | ◯ | 60 | 5500 | 9167 | ◯ |
| Example 7 | <5 | ◯ | 75 | 4500 | 6000 | ◯ |
| Comparative | <5 | X | 70 | 1250 | 1786 | Δ |
| Example 1 | | | | | | |
| Comparative | <5 | X | 85 | 5250 | 6176 | ◯ |
| Example 2 | | | | | | |
| Comparative | 88 | ◯ | 55 | 65 | 118 | X |
| Example 3 | | | | | | |
| Comparative | — | ◯ | 75 | 70 | 93 | X |
| Example 4 | | | | | | |
| Comparative | <5 | ⊚ | 4250 | 6000 | 141 | X |
| Example 5 | | | | | | |

As found from Table 2, the recyclable sheets of the examples were excellent in the solvent immersion releasability of the release layers (and undercoat layers), and therefore also excellent in the base material recyclability.

### INDUSTRIAL APPLICABILITY

The recyclable sheet according to the present invention can be suitably used, for example, as a release sheet.

### DESCRIPTION OF REFERENCE NUMERALS

1 . . . Recyclable Sheet
   11 . . . Base material
   12 . . . Undercoat Layer
   13 . . . Functional Layer

1. A recyclable sheet comprising:
a base material;
an undercoat layer provided on at least one surface side of the base material; and
a functional layer provided on the undercoat layer on a side opposite the base material,
the undercoat layer containing a cyclodextrin compound.

2. The recyclable sheet according to claim 1, wherein a material constituting the undercoat layer has a gel fraction of 20% or less.

3. The recyclable sheet according to claim 1, wherein the undercoat layer contains the cyclodextrin compound as a monomer.

4. The recyclable sheet according to claim 1, wherein the cyclodextrin compound is a compound in which some or all of hydroxyl groups of cyclodextrin are substituted with acyl groups.

5. The recyclable sheet according to claim 1, wherein the undercoat layer contains an acrylic monomer.

6. The recyclable sheet according to claim 1, wherein a content of the cyclodextrin compound in the undercoat layer is 0.01 mass % or more and 30 mass % or less.

7. The recyclable sheet according to claim 1, wherein the undercoat layer has a thickness of 0.01 μm or more and 10 μm or less.

8. The recyclable sheet according to claim 1, wherein
the functional layer is a release agent layer, and
the recyclable sheet is a release sheet.
